(19) United States
(12) Patent Application Publication
(10) Pub. No.: US 2026/0367727 A1
(43) Pub. Date: Nov. 19, 2026

(54) DISPLAY DEVICE

(71) Applicant: Sharp Display Technology Corporation, Kameyama City (JP)

(72) Inventors: Takahiro NAKAYAMA, Kameyama City (JP); Kohji Saitoh, Kameyama City (JP)

(21) Appl. No.: 19/670,167

(22) Filed: May 7, 2026

(30) Foreign Application Priority Data
May 16, 2025 (JP) 2025-082628

(51) Int. Cl. G06F 3/041

(52) U.S. Cl. CPC G06F 3/0416; G06F 3/0412

(57) ABSTRACT

A display device comprises a display panel, a display control unit, a position detecting unit, and a control unit. The display panel includes a first electrode and a second electrode. The control unit is configured to switch between a first mode driving both units and a second mode driving the display control unit but not the position detecting unit. The control unit causes, in the first mode, a frame period to include a display period DP supplying an image signal to the first electrode and a potential signal to the second electrode and a position detecting period supplying a position detecting signal from the position detecting unit to the second electrode, and, in the second mode, the frame period to include the display period DP without the position detecting period.

### CROSS-REFERENCE TO RELATED APPLICATION

The present application claims priority from Japanese Application JP2025-82628, filed on May 16, 2025, the content of which is hereby incorporated by reference into this application.

### BACKGROUND

### 1. Field

The present specification discloses techniques related to display devices that allow for reduced power consumption.

### 2. Description of the Related Art

The devices described in JP2013-232162A and JP2013-025584A have been known as an example of device that has a position detecting function. JP2013-232162A describes a liquid crystal display device with a touch panel as a device that has a position detecting function. The liquid crystal display device with a touch panel described in JP2013-232162A includes: pixel electrodes that are a plurality of electrodes each of which is provided in one of pixels in a display area and to each of which an electrical potential is applied in accordance with a gray level; common electrodes that are a plurality of electrodes extending in a single direction across the display area; detection electrodes that are a plurality of electrodes extending in a different direction from the single direction across the display area to detect a contact position on the panel; a liquid crystal layer containing a liquid crystal composition that changes orientation with an electric field formed by the pixel electrodes and the common electrodes; and a contact position detection control unit for controlling the detection of the contact position on the panel, wherein the contact position detection control unit controls the detection of the contact position in a power-saving mode if no contact is detected for a prescribed period of time.

JP2013-025584A describes an information processing device as a device that has a position detecting function. The information processing device described in JP2013-025584A includes: a touch panel; and an attachment/detachment detection unit for detecting either an attached state in which a pen-shaped operation tool is attached to a housing of the information processing device or a detached state in which the operation tool is detached from the housing of the information processing device, wherein operation position detecting conditions under which the operation position of a finger or the operation tool on the touch panel is detected are switched in accordance with the attachment/detachment state, of the operation tool, detected by the attachment/detachment detection unit.

### SUMMARY

In the aforementioned liquid crystal display device with a touch panel described in JP2013-232162A, a voltage for position detection is fed to a sleep mode canceling electrode even in sleep mode, which is a power-saving mode. Therefore, the period for writing to a pixel is shortened by the period for supplying a voltage for position detection to the sleep mode canceling electrode. Given a shorter period for writing to the pixel, the image signal needs to rise quickly to reach the intended voltage, which could lead to increased power consumption.

In the aforementioned information processing device described in JP2013-025584A, the touch panel is continuously performing position detection in both manual operation mode and tool-based operation mode.

Therefore, if the touch panel described in JP2013-025584A is designed to have an in-cell structure in the liquid crystal display device, the period for writing to a pixel is shortened by the period for position detection in the same manner as in JP2013-232162A. As a result, power consumption could increase.

The techniques described in the present specification have been completed in view of these circumstances and have an object to allow for reducing power consumption.
(1) A display device in accordance with a technique described in the present specification includes: a display panel; a display control unit configured to control a display on the display panel; a position detecting unit configured to detect an input position where an input is made on the display panel; and a control unit configured to control the display control unit and the position detecting unit, wherein the display panel includes: a first electrode included in a pixel that is a display unit; and a second electrode provided overlapping the first electrode at a distance so as to be capable of generating an electric field between the second electrode and the first electrode, the control unit is configured to be capable of switching between a first mode in which both the display control unit and the position detecting unit are driven and a second mode in which the display control unit is driven, but the position detecting unit is not driven, and the control unit: in the first mode, causes a single frame period that is a period in which to display a single image to include a display period in which to supply an image signal from the display control unit to the first electrode and to supply a common potential signal from the display control unit to the second electrode and to additionally include a position detecting period in which to supply a position detecting signal from the position detecting unit to the second electrode, and in the second mode, causes the single frame period to include the display period, but not to include the position detecting period.
(2) In addition, the display device may be configured, in addition to (1) described above, such that the display control unit causes a rate of change of a voltage until a targeted voltage value is reached on a waveform of the image signal to be smaller in the second mode than in the first mode.

The techniques described in the present specification allow for reducing power consumption.

### BRIEF DESCRIPTION OF DRAWINGS

FIG. 1 is a plan view of, for example, a liquid crystal panel, a flexible substrate, and a control board in a liquid crystal display device in accordance with Embodiment 1.

FIG. 2 is a cross-sectional view of, for example, a liquid crystal panel, a flexible substrate, and a control board in accordance with Embodiment 1.

FIG. 3 is a circuit diagram of an electrical structure of an array substrate in the liquid crystal panel in accordance with Embodiment 1.

FIG. 4 is a timing chart showing timings of a starting period and a finishing period in a display period and a touch detecting period included in a single frame period in a first mode in accordance with Embodiment 1.

FIG. 5 is a timing chart showing timings of a starting period and a finishing period in a display period included in a single frame period in a second mode in accordance with Embodiment 1.

FIG. 6 is a diagram representing a waveform in accordance with a scan signal and an image signal in the first mode in accordance with Embodiment 1.

FIG. 7 is a diagram representing a waveform in accordance with a scan signal and an image signal in the second mode in accordance with Embodiment 1.

FIG. 8 is a flow chart related to a switching process for the first mode and the second mode in accordance with Embodiment 1.

FIG. 9 is a flow chart related to a switching process for the first mode and the second mode in accordance with Embodiment 2.

### DESCRIPTION OF EMBODIMENTS

### Embodiment 1

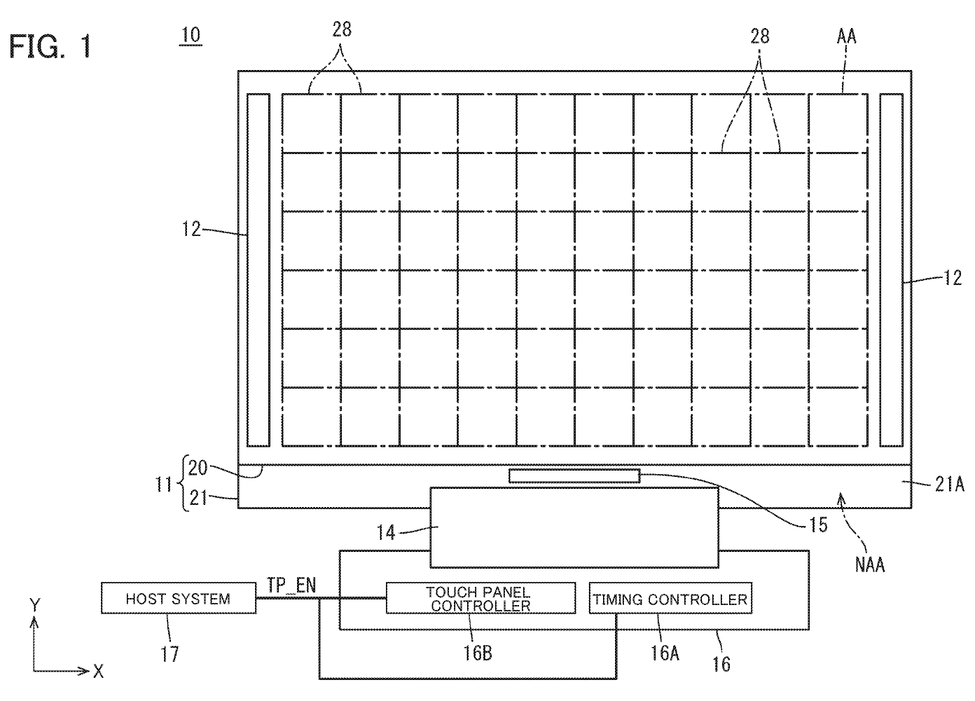

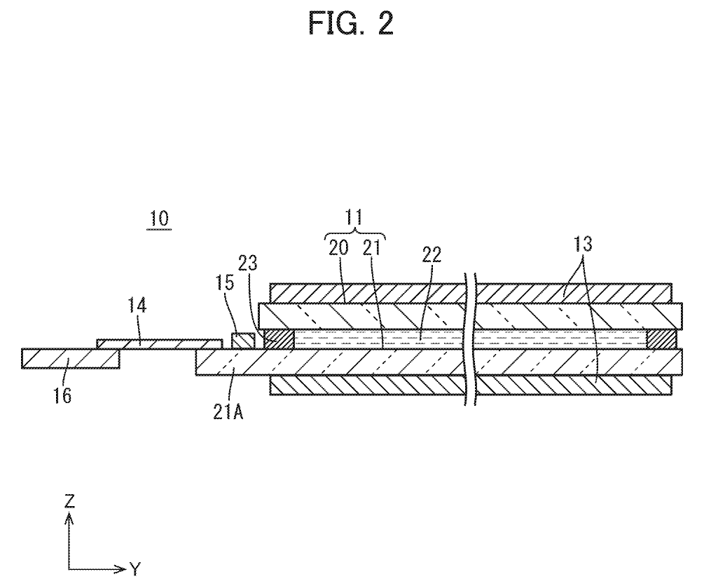

A description is now given of Embodiment 1 with reference to FIGS. 1-8. The present embodiment discusses, as an example, a liquid crystal display device 10 that has a display function and a touch panel function (position-dependent input function). Note that an X-axis, a Y-axis, and a Z-axis are shown in a part of each drawing, and each axial direction is drawn to be a direction shown in each drawing. In addition, the upper side in FIG. 2 is the front side, and the lower side in FIG. 2 is the back side.

Referring to FIG. 1, the liquid crystal display device 10 includes at least: a liquid crystal panel (display device, display panel) 11 shaped like a horizontally elongated rectangle where images can be displayed; and a backlight device (lighting device) that is an external light source for illuminating the liquid crystal panel 11 with light for use in producing the displays. The backlight device is provided on the back side (rear side) of the liquid crystal panel 11 and has a known structure. The liquid crystal panel 11 has, in a central portion of its primary face, a display area AA where images are displayed and has, in a frame-shaped peripheral portion surrounding the display area AA, a non-display area NAA where no images are displayed.

Referring to FIG. 1, there are provided a pair of gate circuit units 12 in the non-display area NAA of the liquid crystal panel 11. The pair of gate circuit units 12 is disposed externally flanking the display area AA in terms of the X-axis direction. Each gate circuit unit 12 is disposed in a band-shaped region extending in the Y-axis direction. The gate circuit unit 12 is for supplying scan signals to gate lines 26 (detailed later) and formed monolithically on an array substrate 21 (detailed later). The gate circuit unit 12 is a GDM (gate driver monolithic) circuit. The gate circuit unit 12 includes, for example: a shift register circuit for outputting scan signals at prescribed timings; and a buffer circuit for amplifying the scan signals.

The liquid crystal panel 11 in accordance with the present embodiment has both a display function of displaying images and a touch panel function of detecting the position (input position) where the user has made an input on the basis of the displayed image and includes an integrated (in-cell) touch panel pattern for realizing the touch panel function. An overview is now given of the configuration related to the touch panel function. The touch panel pattern for realizing the touch panel function is of a so-called projected-capacitance type, and its detection scheme is of a self-capacitance type. Referring to FIG. 1, the touch panel pattern includes a plurality of touch electrodes (second electrodes, position detecting electrodes) 28 that are arranged in the X-axis direction and the Y-axis direction like in a matrix on the surface of the liquid crystal panel 11. The touch electrodes 28 are disposed in the display area AA of the liquid crystal panel 11. Therefore, the display area AA of the liquid crystal panel 11 generally matches a touch area (position-dependent input area) where input positions are detectable, and the non-display area NAA generally matches a non-touch area (non-position-dependent input area) where input positions are not detectable. Then, when the user moves a detection object such as his/her finger or a touch pen closer to the surface of the liquid crystal panel 11 to make a position-dependent input on the basis of the visually recognized image in the display area AA of the liquid crystal panel 11, an electrostatic capacitance is formed between the detection object and the touch electrodes 28. Hence, the electrostatic capacitance as detected by the touch electrodes 28 located close to the detection object changes with the approach of the finger and deviates from the electrostatic capacitance as detected by the touch electrodes 28 located removed from the detection object, and the input position can be detected on the basis of it. Note that the specific number of the touch electrodes 28 provided is not limited to the example shown in FIG. 1 and may be altered where appropriate. The touch electrode 28 is generally rectangular in a plan view and has sides of approximately a few millimeters in length. Therefore, the touch electrode 28 is far larger in size than a pixel PX in a plan view and is provided across a plurality of pixels PX both in terms of the X-axis direction and in terms of the Y-axis direction.

Referring to FIGS. 1 and 2, the liquid crystal panel 11 includes a pair of substrates 20 and 21 attached together. Of this pair of substrates 20 and 21, the front side is the opposite substrate 20, and the back side (rear side) is the array substrate 21. The opposite substrate 20 and the array substrate 21 include: respective glass substrates (support substrates); and various films stacked on their inner face sides. Between the pair of substrates 20 and 21 is there interposed a liquid crystal layer (medium layer) 22 containing liquid crystal molecules which are a substance that changes its optical properties in response to an electric field applied to it. Between the outer peripheral portions of the pair of substrates 20 and 21 is there interposed a sealing section 23 for sealing the liquid crystal layer 22. The sealing section 23 is shaped like a rectangular frame (like an endless ring) surrounding the liquid crystal layer 22. Note that a polarizer 13 is attached to each of the outer face sides of the substrates 20 and 21.

Referring to FIGS. 1 and 2, the opposite substrate 20 has a short-side dimension that is shorter than the short-side dimension of the array substrate 21. The opposite substrate 20 is attached to the array substrate 21 so that one of the two end portions of each substrate in terms of the short-side direction (Y-axis direction) is aligned. Therefore, the other end portion of the array substrate 21 in terms of the short-side direction is an exposed portion 21A that projects sideways from the opposite substrate 20 and is hence exposed. This exposed portion 21A is entirely the non-display area NAA and has, mounted thereto, a flexible substrate 14 and a driver (signal supply section) 15 for supplying various signals. The flexible substrate 14 is connected, at one of its two ends, to the exposed portion 21A and connected, at its other end, to a control board 16, to transfer signals from the control board 16 to the array substrate 21. The driver 15 includes an LSI chip including a drive circuit therein and supplies, for example, an image signal to a source line 27 (detailed later) by processing various signals transferred by the flexible substrate 14. In addition, the gate circuit unit 12 is connected to the flexible substrate 14 or the driver 15 through connection wires and is configured to receive, for example, various signals (e.g., a gate start pulse signal) and power supply voltage from the flexible substrate 14 or the driver 15.

The control board 16 includes a plurality of circuit components mounted to a rigid substrate made of a synthetic resin (e.g., phenolic paper or glass epoxy resin). Referring to FIG. 1, the plurality of circuit components include, for example: a timing controller (display control unit) 16A for controlling the display function; a touch panel controller (position detecting unit) 16B for controlling the touch panel function; a power supply IC (integrated circuit) that is a DC power supply for outputting electric power; and a level shifter IC for controlling (stepping down and stepping up) the voltage level. The timing controller 16A can generate various signals to be supplied to the flexible substrate 14 and the driver 15. The touch panel controller 16B can detect an input position where the user has made an input on the liquid crystal panel 11 by using a detection object (position input body) such as a finger or a touch pen. The control board 16 includes a connector unit to which, for example, the flexible substrate 14 is connected. The control board 16 is disposed overlapping the back side of backlight device by bending the flexible substrate 14 in a folded manner.

Referring to FIG. 1, a host system (control unit) 17 is connected to the control board 16. The host system 17 can supply video signals for images displayed on the liquid crystal panel 11 to the timing controller 16A and also supply a mode-switching signal (detailed later) to the timing controller 16A and the touch panel controller 16B. The timing controller 16A and the touch panel controller 16B are configured so that their operation can be controlled on the basis of the switching signal supplied from the host system 17.

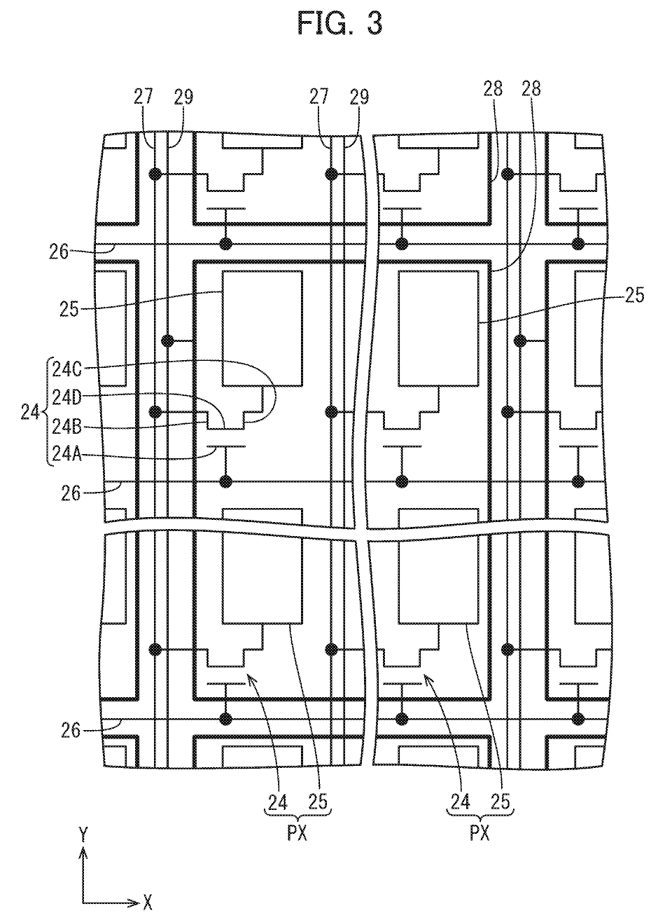

A description is given next of the structure of the display area AA of the array substrate 21 with reference to FIG. 3. Referring to FIG. 3, on the inner face of the display area AA of the array substrate 21, there are provided at least TFTs (switching elements, thin film transistors) 24 and pixel electrodes (first electrodes) 25. The TFTs 24 and the pixel electrodes 25, together with color filters (detailed later), form the pixels PX each of which is a display unit. The TFTs 24 and the pixel electrodes 25 are arranged in X-axis-wise rows and Y-axis-wise columns at intervals like a matrix. Around the TFTs 24 and the pixel electrodes 25, there are provided gate lines (scan lines) 26 and source lines (image lines, signal wiring lines) 27 that intersect orthogonally with (cross) each other. The gate lines 26 extend in the X-axis direction and are disposed at intervals in terms of the Y-axis direction. The source lines 27 extend in the Y-axis direction and are disposed at intervals in terms of the X-axis direction. Each TFT 24 includes: a gate electrode 24A connected to one of the gate lines 26; a source electrode 24B connected to one of the source lines 27; a drain electrode 24C connected to one of the pixel electrodes 25; and a semiconductor segment 24D connected to the source electrode 24B and the drain electrode 24C. Then, the TFT 24 is driven on the basis of a scan signal supplied by the gate line 26 from the gate circuit unit 12 to the gate electrode 24A. This scan signal includes a higher electrical potential than the threshold voltage of the TFT 24 (HIGH potential). Accordingly, a channel region forms in the semiconductor segment 24D, and therefore, the voltage related to the image signal supplied from the driver 15 to the source electrode 24B through the source line 27 is fed to the drain electrode 24C via the channel region in the semiconductor segment 24D. As a result, the pixel electrode 25 is charged to the voltage related to the image signal. Each pixel electrode 25 is disposed in a region surrounded by one of the gate lines 26 and one of the source lines 27 and is, for example, generally rectangular in a plan view.

Referring to FIG. 3, each touch electrode 28 is provided at a distance over a plurality of pixel electrodes 25 in terms of the Z-axis direction (normal to the primary face of the liquid crystal panel 11). More specifically, the touch electrode 28 overlaps all those pixel electrodes 25 that are present in the region in which the touch electrode 28 is positioned and separated from these pixel electrodes 25 by an intervening insulation film. The touch electrodes 28 and the overlapped pixel electrodes 25 are kept insulated from each other by the insulation film keeping the Z-axis-wise distance between the touch electrodes 28 and the pixel electrodes 25. Touch lines 29 provided on the array substrate 21 are connected to the touch electrodes 28. The touch lines 29 extend generally in the Y-axis direction and are parallel to the source lines 27. A plurality of touch lines 29 are provided next to each other at intervals in terms of the X-axis direction. An end portion of each touch line 29 in the Y-axis direction is a terminal section, and this terminal section is connected to the flexible substrate 14 or the driver 15.

The touch line 29 is configured to be fed, by time division, with a common potential signal (reference potential signal) related to the display function and a touch signal (position detecting signal) related to the touch panel function both from the flexible substrate 14 or the driver 15 to which the touch line 29 is connected. The common potential signal is outputted by the timing controller 16A and supplied to the touch line 29 via, for example, the flexible substrate 14 and the driver 15. The touch signal is outputted by the touch panel controller 16B and supplied to the touch line 29 via, for example, the flexible substrate 14 and the driver 15. The touch lines 29 can transfer, for example, the common potential signal and the touch signal to the touch electrodes 28. The touch electrode 28 can generate an electric field between the touch electrode 28 and the pixel electrodes 25 charged to the voltage that is based on the image signal during the period in which the touch line 29 is supplying the common potential signal. The orientation of the liquid crystal molecules is controlled on the basis of the electric field generated between the touch electrode 28 and the pixel electrodes 25 so that the pixels PX can produce a prescribed grayscale display on the basis of this orientation of the liquid crystal molecules. Throughout the following description, the period in which the common potential signal is supplied to the touch electrode 28 is referred to as the “display period DP.” In the display period DP, the touch electrode 28 is brought to a common potential that is based on the common potential signal. Meanwhile, during the period in which the touch signal is supplied to the touch electrode 28 by the touch line 29, the touch panel controller 16B can detect changes in the electrostatic capacitance formed between the touch electrode 28 and the detection object and can detect the input position on the liquid crystal panel 11 on the basis of the changes in the electrostatic capacitance. Throughout the following description, the period in which the touch signal is supplied to the touch electrode 28 is referred to as the “touch detecting period (position detecting period, sensing period) TP.”

In addition, there are provided a plurality of color filters at locations opposite the pixel electrodes 25 on the array substrate 21 side of the display area AA of the opposite substrate 20. In the color filters, the three colors, R (red), G (green), and B (blue), are repeatedly arranged adjacent to each other in a prescribed order to form the three-color pixels PX (red pixels, green pixels, and blue pixels) in combination with the TFTs 24 and the pixel electrodes 25. Three pixels PX (a red pixel, a green pixel, and a blue pixel) form a display pixel capable of performing a color display with prescribed gray levels. In addition, a light-blocking section (black matrix) for preventing color mixing is provided between the color filters. Note that an alignment film for aligning the liquid crystal molecules contained in the liquid crystal layer 22 is provided on each of the innermost faces of the opposite substrate 20 and the array substrate 21.

Now, referring to FIG. 1, the host system 17 in accordance with the present embodiment is configured to be capable of switching between a first mode in which both the timing controller 16A and the touch panel controller 16B are driven and a second mode in which the timing controller 16A is driven, but the touch panel controller 16B is not driven. In the first mode, both the display function by which to display images and the touch panel function by which to detect the input position made with the detection object are performed. In the second mode, the display function is performed, but the touch panel function is not performed. Therefore, the second mode can be referred to as the “low power consumption mode” because the power consumption is restrained as much as the power consumption by the touch panel function, which is not performed, when compared with the first mode. In contrast, the first mode can be referred to as the “default mode” in which the touch panel function is performed.

Specifically, the host system 17 is configured to supply a switching signal TP_EN for switching between the first mode and the second mode to the timing controller 16A and the touch panel controller 16B. The switching signal TP_EN has a HIGH-level potential (hereinafter, “HIGH potential H”) and a LOW-level potential (hereinafter, “LOW potential L”). The timing controller 16A and the touch panel controller 16B are configured to perform the first mode upon receiving the HIGH potential H of the switching signal TP_EN from the host system 17. The timing controller 16A and the touch panel controller 16B are configured to perform the second mode upon receiving the LOW potential L of the switching signal TP_EN from the host system 17. In other words, the host system 17 can control the switching between the first mode and the second mode by changing the potential level of the switching signal TP_EN.

The host system 17, in the first mode, drives both the timing controller 16A and the touch panel controller 16B so that a single frame period that is a period for displaying a single image can include a display period DP and a touch detecting period TP. In other words, when the HIGH potential H of the switching signal TP_EN is supplied from the host system 17 to the timing controller 16A and the touch panel controller 16B, the timing controller 16A and the touch panel controller 16B are both driven. In the display period DP, image signals are supplied from the timing controller 16A to the pixel electrodes 25, and the common potential signal is also supplied from the touch panel controller 16B to the touch electrodes 28. Hence, in the display period DP, an electric field is generated between the pixel electrodes 25 and the touch electrodes 28, and this electric field allows the pixels PX to be set to prescribed display gray levels. In the touch detecting period TP, a touch signal is supplied from the touch panel controller 16B to the touch electrodes 28. Hence, the touch panel controller 16B can detect the input position on the liquid crystal panel 11 on the basis of a change in the electrostatic capacitance generated between the detection object used to make a position-dependent input on the liquid crystal panel 11 and the touch electrodes 28.

In the second mode, the host system 17 drives the timing controller 16A, but does not drive the touch panel controller 16B so that a single frame period can include the display period DP and no touch detecting period TP. In other words, when the LOW potential L of the switching signal TP_EN is supplied from the host system 17 to the timing controller 16A and the touch panel controller 16B, the timing controller 16A is driven, but the touch panel controller 16B is configured to be in a non-driven state. In the second mode, a single frame period is exclusively the display period DP, and no touch signal is supplied to the touch electrodes 28. Therefore, the image signals supplied from the timing controller 16A to the pixel electrodes 25 in the display period DP are allowed to rise gradually until they reach a targeted voltage value V_{L}. This particular configuration enables reducing power consumption.

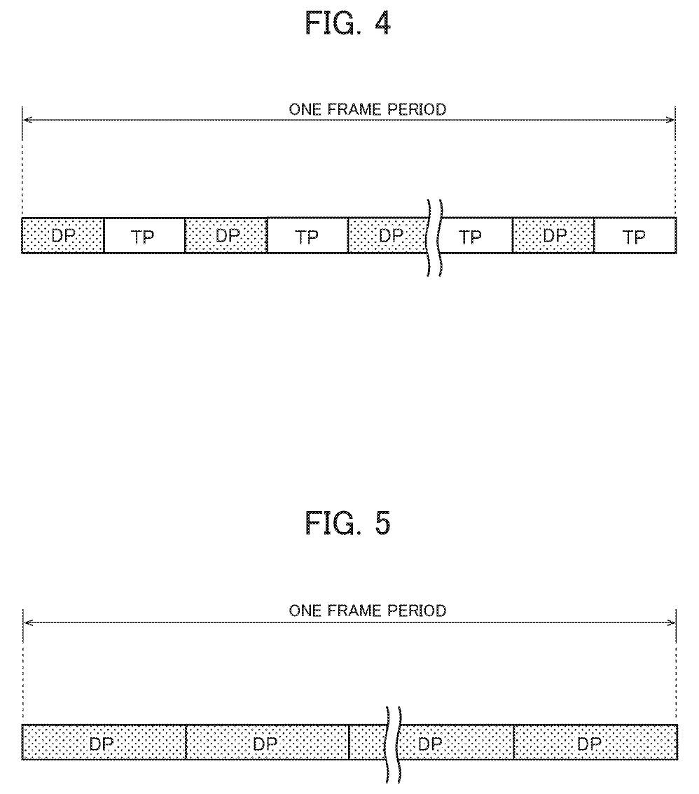

A description is now given of the first mode and the second mode with reference to the timing charts shown in FIGS. 4 and 5. FIGS. 4 and 5 show timings of a starting period and a finishing period in, for example, the display period DP and the touch detecting period TP included in a single frame period. A description is given of the first mode with reference to FIG. 4. In the first mode, the display period DP and the touch detecting period TP are alternately repeated from the start of a single frame period to the end of the single frame period (while writing a single image). Specifically, at the start of a single frame period, a first display period DP is started so that the HIGH potential of the scan signal is supplied from the gate circuit units 12 sequentially to a prescribed number of gate lines 26 including the gate line 26 positioned on the topmost row of the display area AA. The image signals are supplied from the driver 15 to the plurality of source lines 27 in synchronism with the supply of the scan signal, to write to the pixels PX. While doing this, the common potential signal is supplied to all the touch electrodes 28. At the end of the first display period DP, the first touch detecting period TP is started. In response to this, a touch detection is performed by supplying a touch signal to all the touch electrodes 28. At the end of the first touch detecting period TP, a second display period DP is started so that the HIGH potential of the scan signal is supplied from the gate circuit units 12 sequentially to a prescribed number of gate lines 26 including the gate line 26 positioned in the row next to the gate line 26 to which the scan signal was supplied last in the first display period DP, writing to the pixels PX is also performed, and the common potential signal is supplied to all the touch electrodes 28. Thereafter, a second touch detecting period TP is started, and the process is configured to continue in this manner by alternately repeating the display period DP and the touch detecting period TP. Note that the number of the gate lines 26 to which the HIGH potential of the scan signal is supplied in one display period DP is equal to the value obtained by dividing the total number of the gate lines 26 provided in the liquid crystal panel 11 by the number of times the display period DP is repeat in one frame period. In addition, in the present embodiment, the display period DP and the touch detecting period TP are configured to have approximately the same duration.

A description is given of the second mode with reference to FIG. 5. In the second mode, the display period DP is included alone, and no touch detecting period TP is included, from the start of a single frame period to the end of the single frame period. In other words, in the second mode, the common potential signal is continuously supplied to all the touch electrodes 28, and the touch signal is supplied to none of the touch electrodes 28. Specifically, at the start of a single frame period, a first display period DP is started so that the writing to the pixel PX is performed in the same manner as in the first mode. At the end of the first display period DP, a second display period DP is started, and the process is configured to continue in this manner by repeating the display period DP. As described here, in the second mode, the display period DP is lengthened as much as the excluded touch detecting period TP. For example, if the display period DP is repeated the sane number of times in one frame period in the first mode and the second mode, the duration of a single display period DP is approximately twice as long in the second mode as in the first mode. In other words, the length of time that can be used to write to the pixels PX (the write period for the pixels PX) is approximately twice long in the second mode than in the first mode.

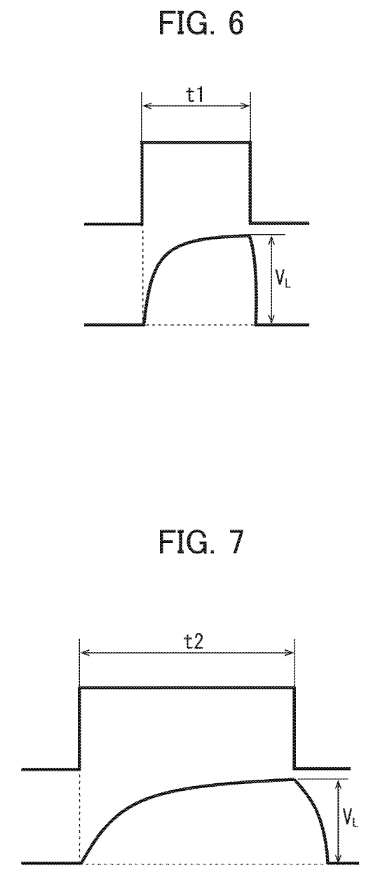

A description is given next of waveforms related to the scan signal and the image signal in the first mode and the second mode with reference to FIGS. 6 and 7. In the first mode, the period in which the scan signal has the HIGH potential (write period for the pixels PX) is denoted by “t1” as shown in FIG. 6. The voltage of the image signal is configured to rise in synchronism with the timing of the rise of the scan signal from the LOW potential to the HIGH potential and then continuously change at a prescribed rate of change during the period t1 until it reaches the targeted voltage value V_{L}. In the first mode, the timing controller 16A determines the rate of change of the voltage of the image signal on the basis of the period t1 and the targeted voltage value V_{L}.

In the second mode, the period in which the scan signal has the HIGH potential is denoted by “t2” as shown in FIG. 7. The period t2 is longer than the period t1 and is specifically set to approximately twice the period t1. The voltage of the image signal is configured to rise in synchronism with the timing of the rise of the scan signal from the LOW potential to the HIGH potential and then continuously change at a prescribed rate of change during the period t2 until it reaches the targeted voltage value V_{L}. In the second mode, the timing controller 16A determines the rate of change of the voltage of the image signal on the basis of the period t2 and the targeted voltage value V_{L}, and the value of this rate of change is smaller than the rate of change of the voltage of the image signal in the first mode. In other words, the voltage of the image signal can rise more slowly in the second mode than in the first mode. Hence, the timing controller 16A can generate the image signal and still reduce the electric power required for the output, thereby allowing for reduced power consumption.

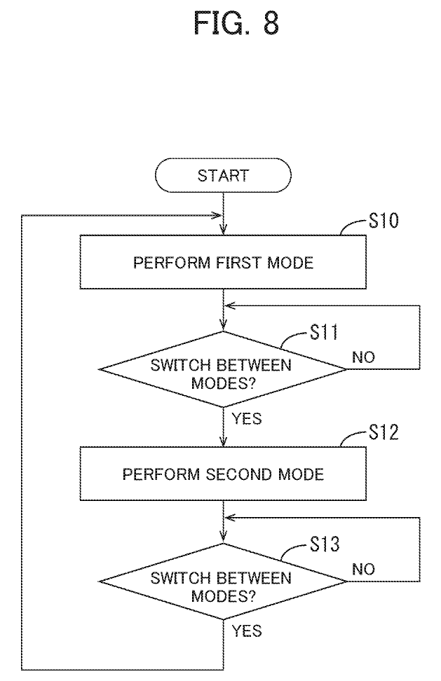

A description is given next of a switching process for the first mode and the second mode with reference to a flow chart in FIG. 8. After the power supply of the liquid crystal display device 10 is turned on, at first, the switching signal TP_EN outputted by the host system 17 is set to the HIGH potential H as shown in FIG. 8, and for this reason, the first mode is performed (step S10). Thereafter, the host system 17 determines whether or not a mode-switching operation has been inputted (step S11). This “mode-switching operation” is, for example, a change in settings which the user instructs the host system 17 to do, like “switch to low power consumption mode (second mode).” If no mode-switching operation has been inputted, the process returns to step S11. If the mode-switching operation has been inputted, the switching signal TP_EN outputted by the host system 17 is changed from the HIGH potential H to the LOW potential L, and for this reason, the second mode is performed (step S12). Thereafter, the host system 17 determines whether or not the mode-switching operation has been inputted (step S13). This “mode-switching operation” is, for example, a change in settings which the user instructs the host system 17 to do, like “switch to default mode (first mode).” If no mode-switching operation has been inputted, the process returns to step S13. If the mode-switching operation has been inputted, the switching signal TP_EN outputted by the host system 17 is changed from the LOW potential L to the HIGH potential H, and for this reason, the first mode is performed (step S10). The switching process for the first mode and the second mode is performed in this manner.

As described so far, the liquid crystal display device (display device) 10 in accordance with the present embodiment includes: a liquid crystal panel (display panel) 11; a timing controller (display control unit) 16A configured to control a display on the liquid crystal panel 11; a touch panel controller (position detecting unit) 16B configured to detect an input position where an input is made on the liquid crystal panel 11; and a host system (control unit) 17 configured to control the timing controller 16A and the touch panel controller 16B, wherein the liquid crystal panel 11 includes: a pixel electrode (first electrode) 25 included in a pixel PX that is a display unit; and a touch electrode (second electrode) 28 provided overlapping the pixel electrode 25 at a distance so as to be capable of generating an electric field between the touch electrode 28 and the pixel electrode 25, the host system 17 is configured to be capable of switching between a first mode in which both the timing controller 16A and the touch panel controller 16B are driven and a second mode in which the timing controller 16A is driven, but the touch panel controller 16B is not driven, and the host system 17: in the first mode, causes a single frame period that is a period in which to display a single image to include a display period DP in which to supply an image signal from the timing controller 16A to the pixel electrode 25 and to supply a common potential signal from the timing controller 16A to the touch electrode 28 and to additionally include a touch detecting period (position detecting period) TP in which to supply a touch signal from the touch panel controller 16B to the touch electrode 28, and in the second mode, causes a single frame period to include the display period DP, but not to include the touch detecting period TP.

In the first mode, both the timing controller 16A and the touch panel controller 16B are driven by the host system 17, and in the display period DP included in the single frame period, an image signal is supplied from the timing controller 16A to the pixel electrode 25, and a common potential signal is supplied from the timing controller 16A to the touch electrode 28. Hence, in the display period DP, an electric field is generated between the pixel electrode 25 and the touch electrode 28, and the pixel PX can be set to a prescribed display gray level by means of the electric field. Meanwhile, in the touch detecting period TP included in the single frame period, a touch signal is supplied from the touch panel controller 16B to the touch electrode 28. Hence, the touch panel controller 16B can detect an input position on the liquid crystal panel 11 on the basis of a change in the electrostatic capacitance generated between the detection object used to make a position-dependent input on the liquid crystal panel 11 and the touch electrode 28.

In the second mode, the timing controller 16A is driven by the host system 17, but the touch panel controller 16B is not driven, so that the single frame period is exclusively the display period DP and that no touch signal is supplied to the touch electrode 28. Therefore, the image signal supplied from the timing controller 16A to the pixel electrode 25 in the display period DP is allowed to rise gradually until it reaches a targeted voltage value. This particular configuration enables reducing power consumption.

In addition, the timing controller 16A causes a rate of change of a voltage until a targeted voltage value V_{L} is reached on a waveform of the image signal to be smaller in the second mode than in the first mode. The waveform of the image signal is configured to, after the voltage has risen, continuously change at a prescribed rate of change until it reaches the targeted voltage value V_{L}. In the second mode, since a single frame period is exclusively the display period DP, the write period for the pixel PX is longer than in the first mode. Therefore, the timing controller 16A can cause a rate of change of a voltage until the targeted voltage value V_{L} is reached on a waveform of the image signal to be smaller in the second mode than in the first mode. Hence, the timing controller 16A can generate the image signal and still reduce the electric power required for the output, thereby allowing for reduced power consumption.

### Embodiment 2

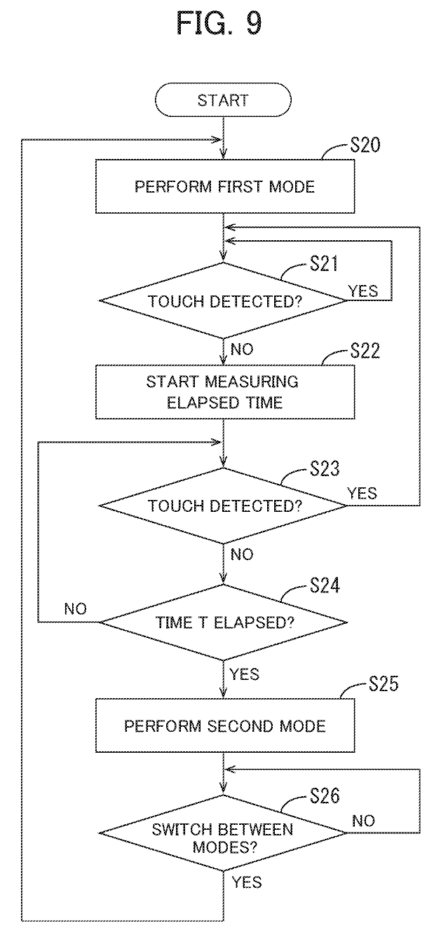

A description is given of Embodiment 2 with reference to FIG. 9. This Embodiment 2 discusses a change in, for example, the switching process for the first mode and the second mode. Note that no description will be repeated on the same structure, operation, and effects as those in Embodiment 1 described above.

The host system 17 in accordance with the present embodiment is configured to supply a switching signal TP_T for switching between the first mode and the second mode to the timing controller 16A and the touch panel controller 16B. The switching signal TP_T has a HIGH potential H and a LOW potential L. The timing controller 16A and the touch panel controller 16B are configured to perform the first mode upon receiving the LOW potential L of the switching signal TP_T from the host system 17. The timing controller 16A and the touch panel controller 16B are configured to perform the second mode upon receiving the HIGH potential H of the switching signal TP_T from the host system 17. The switching signal TP_T in accordance with the present embodiment is configured so that the HIGH potential H and the LOW potential L have their relationship reversed when compared to the switching signal TP_EN described in Embodiment 1.

In the present embodiment, the host system 17 is configured to change the switching signal TP_T from the LOW potential L to the HIGH potential H if there is no touch detection (detection of an input position) for a prescribed period of time in the first mode. A description is given of the switching process for the first mode and the second mode with reference to a flow chart in FIG. 9. After the power supply of the liquid crystal display device 10 is turned on, at first, the switching signal TP_T outputted by from the host system 17 is set to the LOW potential L as shown in FIG. 9, and for this reason, the first mode is performed (step S20). Thereafter, the host system 17 determines the presence/absence of a touch detection (step S21). In relation to this “determination on the presence/absence of a touch detection,” the host system 17 determines that “there is a touch detection” if a change has occurred in the electrostatic capacitance of any of the touch electrodes 28 in the touch detecting period TP and determines that “there is no touch detection” if a change has occurred in the electrostatic capacitance of none of the touch electrodes 28. If the host system 17 determines that “there is a touch detection,” the process returns to step S21. If the host system 17 determines that “there is no touch detection,” the host system 17 starts measuring elapsed time (step S22). In other words, the elapsed time during which no touch has been detected by the host system 17 (the time elapsed since the last touch detection) is measured. Note that the host system 17 includes a timer for measuring elapsed time.

The host system 17 determines the presence/absence of a touch detection even after it starts measuring elapsed time (step S23). If the host system 17 determines that “there is a touch detection,” the process returns to step S21 where the measured time is reset. If the host system 17 determines that “there is no touch detection,” the host system 17 continuously measures elapsed time and compares the measured time with a predetermined time. A time T is a value specified on the basis of, for example, a target value for reduced power consumption and the operating environment of the liquid crystal display device 10. Note that the host system 17 includes a memory for storing the time T. If the measured time is less than the time T, the process returns to step S23. If the measured time has reached the time T, the switching signal TP_T outputted by the host system 17 is changed from the LOW potential L to the HIGH potential H, and for this reason, the second mode is performed (step S25). In so doing, the host system 17 resets the measured time. Thereafter, the host system 17 determines whether or not a mode-switching operation has been inputted (step S26). This “mode-switching operation” is, for example, a change in settings which the user instructs the host system 17 to do, like “switch to default mode (first mode).” If no mode-switching operation has been inputted, the process returns to step S26. If a mode-switching operation has been inputted, the switching signal TP_T outputted by the host system 17 is changed from the HIGH potential H to the LOW potential L, and for this reason, the first mode is performed (step S20). The switching process for the first mode and the second mode is performed in this manner.

### Other Embodiments

The technology disclosed in the present specification is not necessarily limited to the embodiments discussed in the foregoing description with reference to drawings. As an example, the following embodiments are also encompassed in the technical scope of the present specification.
(1) In Embodiment 1, the first mode may be performed when the switching signal TP_EN has the LOW potential L, and the second mode may be performed when the switching signal TP_EN has the HIGH potential H.
(2) In Embodiment 2, the first mode may be performed when the switching signal TP_T has the HIGH potential H, and the second mode may be performed when the switching signal TP_T has the LOW potential L.
(3) In Embodiment 2, the conditions under which the liquid crystal display device 10 switches from the second mode to the first mode may be “when a prescribed period of time has elapsed since the start of the second mode.”
(4) In Embodiment 2, the conditions under which the liquid crystal display device 10 switches from the first mode to the second mode may be “a mode-switching operation,” and the conditions under which the liquid crystal display device 10 switches from the second mode to the first mode may be “when a prescribed period of time has elapsed since the start of the second mode.”
(5) In the first mode, the duration ratio of the display period DP and the touch detecting period TP in a single frame period is not necessarily 1:1 and may be changed as appropriate.
(6) In the first mode, the first half of a single frame period may be the display period DP, and the second half may be the touch detecting period TP. When this is the case, the HIGH potential of the scan signal is supplied to the gate line 26 in the topmost row in a starting part of the display period DP included in the first half of the single frame period, and the HIGH potential of the scan signal is supplied to the gate line 26 in the lowest row in a finishing part of the display period DP.
(7) The common potential signal supplied to the touch electrodes 28 may be outputted by a power supply IC on the control board 16.
(8) The driver 15 may be COF- (chip on film)-mounted to the flexible substrate 14.
(9) The touch panel controller 16B may be mounted to, for example, the flexible substrate 14.
(10) The gate circuit units 12 may be omitted. When this is the case, a gate driver that has similar functions to the gate circuit units 12 may be provided to the array substrate 21. In addition, only a single gate circuit unit 12 may be provided on one of two side regions of the array substrate 21.
(11) The liquid crystal panel 11 may have a plan-view shape such as a vertically elongated rectangle, a square, a circle, a semicircle, an elongated circle, an ellipse, or a trapezoid.
(12) The liquid crystal panel 11 may be replaced by another display panel (e.g., organic EL display panel).

What is claimed is:

1. A display device comprising:
a display panel;
a display control unit configured to control a display on the display panel;
a position detecting unit configured to detect an input position where an input is made on the display panel; and
a control unit configured to control the display control unit and the position detecting unit, wherein
the display panel includes:
a first electrode included in a pixel that is a display unit; and
a second electrode provided overlapping the first electrode at a distance so as to be capable of generating an electric field between the second electrode and the first electrode,
the control unit is configured to be capable of switching between a first mode in which both the display control unit and the position detecting unit are driven and a second mode in which the display control unit is driven, but the position detecting unit is not driven, and
the control unit:
in the first mode, causes a single frame period that is a period in which to display a single image to include a display period in which to supply an image signal from the display control unit to the first electrode and to supply a common potential signal from the display control unit to the second electrode and to additionally include a position detecting period in which to supply a position detecting signal from the position detecting unit to the second electrode, and
in the second mode, causes the single frame period to include the display period, but not to include the position detecting period.

2. The display device according to claim 1, wherein the display control unit causes a rate of change of a voltage until a targeted voltage value is reached on a waveform of the image signal to be smaller in the second mode than in the first mode.
